(19) United States
(12) Patent Application Publication
(10) Pub. No.: US 2023/0214813 A1
(43) Pub. Date: Jul. 6, 2023

(54) SYSTEM AND METHOD PROVIDING A DATA PROCESSING CHANNEL FOR ALTERNATIVE RESOURCE USAGE

(71) Applicant: BANK OF AMERICA CORPORATION, Charlotte, NC (US)

(72) Inventors: Paul Martin Mattison, Sherrills Ford, NC (US); Ann Ta, Scottsdale, AZ (US); Martha Sain McClellan, Lancaster, SC (US)

(73) Assignee: BANK OF AMERICA CORPORATION, Charlotte, NC (US)

(21) Appl. No.: 17/568,116

(22) Filed: Jan. 4, 2022

(51) Int. Cl. G06Q 20/22; G06Q 40/00

(52) U.S. Cl. CPC G06Q 20/227; G06Q 40/12

(57) ABSTRACT

Systems, methods, and computer program products are provided for providing data processing channels for alternative resource usage. The method includes determining a vendor data channel from potential vendor data channel(s) for processing a resource transfer with a user. The method also includes determining a vendor data channel resource value for the potential vendor data channel(s). The vendor data channel resource value is higher for a potential vendor data channel corresponding to a secondary vendor than one corresponding to the primary vendor. The method further includes adjusting a resource transfer value corresponding to the resource transfer based on the vendor data channel resource value. The method still further includes causing an execution of the resource transfer with the determined vendor data channel based on the adjusted resource transfer value in response to determining the vendor resource value is adequate to cover the adjusted resource transfer value.

### TECHNOLOGICAL FIELD

An example embodiment relates generally to providing data processing channels, and more particularly, to providing data processing channels for alternative resource usage.

### BACKGROUND

Resource usage across different data processing channels can be difficult to implement without increasing structural complexity and/or cost. Therefore, owners of data processing channels may be reluctant to allow for cross-channel resource usage, resulting in resources being illiquid. There exists a need for a system that can quickly and efficiently provide a data processing channels that allow for alternative resource usage.

### BRIEF SUMMARY

The following presents a summary of certain embodiments of the disclosure. This summary is not intended to identify key or critical elements of all embodiments nor delineate the scope of any or all embodiments. Its sole purpose is to present certain concepts and elements of one or more embodiments in a summary form as a prelude to the more detailed description that follows.

In an example embodiment, a system for providing data processing channels for alternative resource usage. The system includes at least one non-transitory storage device and at least one processing device coupled to the at least one non-transitory storage device. The at least one processing device is configured to determine a vendor data channel from one or more potential vendor data channels for processing a resource transfer with a user. Each of the potential vendor data channels corresponds to a primary vendor or a secondary vendor. The at least one processing device is also configured to determine a vendor data channel resource value for at least one of the potential vendor data channels. The vendor data channel resource value is higher for a potential vendor data channel corresponding to the secondary vendor than a potential vendor data channel corresponding to the primary vendor. The at least one processing device is further configured to adjust a resource transfer value corresponding to the resource transfer based on the vendor data channel resource value of the determined vendor data channel. The at least one processing device is still further configured to determine whether a balance of an account associated with the user is adequate to cover the adjusted resource transfer value. The at least one processing device is also configured to cause an execution of the resource transfer with the determined vendor data channel based on the adjusted resource transfer value in response to determining the vendor resource value is adequate to cover the adjusted resource transfer value.

In some embodiments, the at least one processing device is further configured to assign a vendor resource value to a resource received from the user with the vendor resource value corresponding to a value of the resource received and the vendor resource value being attributed to the balance of the account associated with the user. In some embodiments, the resource is received from the user at a device located in a primary vendor location.

In some embodiments, the at least one processing device is further configured to update the balance of the account associated with the user based on the adjusted resource transfer value. In some embodiments, the account associated with the user is associated with one or more primary vendors.

In some embodiments, the vendor data channel resource value for vendor data channels associated with the primary vendor is a negative value with the adjusted resource transfer value being less than the original adjusted resource transfer value. In some embodiments, the at least one processing device is further configured to provide a request to the user to deposit more resources into the account associated with the user in response to determining the vendor resource value is adequate to cover the adjusted resource transfer value.

In another example embodiment, a computer program product for providing data processing channels for alternative resource usage is provided. The computer program product includes at least one non-transitory computer-readable medium having computer-readable program code portions embodied therein. The computer-readable program code portions include an executable portion configured to determine a vendor data channel from one or more potential vendor data channels for processing a resource transfer with a user. Each of the potential vendor data channels corresponds to a primary vendor or a secondary vendor. The computer-readable program code portions also include an executable portion configured to determine a vendor data channel resource value for at least one of the potential vendor data channels. The vendor data channel resource value is higher for a potential vendor data channel corresponding to the secondary vendor than a potential vendor data channel corresponding to the primary vendor. The computer-readable program code portions further include an executable portion configured to adjust a resource transfer value corresponding to the resource transfer based on the vendor data channel resource value of the determined vendor data channel. The computer-readable program code portions still further include an executable portion configured to determine whether a balance of an account associated with the user is adequate to cover the adjusted resource transfer value. The computer-readable program code portions also include an executable portion configured to cause an execution of the resource transfer with the determined vendor data channel based on the adjusted resource transfer value in response to determining the vendor resource value is adequate to cover the adjusted resource transfer value.

In some embodiments, the computer-readable program code portions also include an executable portion configured to assign a vendor resource value to a resource received from the user with the vendor resource value corresponding to a value of the resource received and the vendor resource value being attributed to the balance of the account associated with the user. In some embodiment, the resource is received from the user at a device located in a primary vendor location.

In some embodiments, the computer-readable program code portions also include an executable portion configured to update the balance of the account associated with the user based on the adjusted resource transfer value. In some embodiments, the account associated with the user is associated with one or more primary vendors. In some embodiments, the vendor data channel resource value for vendor data channels associated with the primary vendor is a negative value and the adjusted resource transfer value is less than the original adjusted resource transfer value. In some embodiments, the method includes providing a request to the user to deposit more resources into the account associated with the user in response to determining the vendor resource value is adequate to cover the adjusted resource transfer value.

In still another example embodiment, a computer-implemented method for providing data processing channels for alternative resource usage is provided. The method includes determining a vendor data channel from one or more potential vendor data channels for processing a resource transfer with a user. Each of the potential vendor data channels corresponds to a primary vendor or a secondary vendor. The method also includes determining a vendor data channel resource value for at least one of the potential vendor data channels. The vendor data channel resource value is higher for a potential vendor data channel corresponding to the secondary vendor than a potential vendor data channel corresponding to the primary vendor. The method further includes adjusting a resource transfer value corresponding to the resource transfer based on the vendor data channel resource value of the determined vendor data channel. The method still further includes determining whether a balance of an account associated with the user is adequate to cover the adjusted resource transfer value. The method also includes causing an execution of the resource transfer with the determined vendor data channel based on the adjusted resource transfer value in response to determining the vendor resource value is adequate to cover the adjusted resource transfer value.

In some embodiments, the method also includes assigning a vendor resource value to a resource received from the user with the vendor resource value corresponding to a value of the resource received and the vendor resource value being attributed to the balance of the account associated with the user. In some embodiments, the method also includes updating the balance of the account associated with the user based on the adjusted resource transfer value.

In some embodiments, the account associated with the user is associated with one or more primary vendors. In some embodiments, the vendor data channel resource value for vendor data channels associated with the primary vendor is a negative value and the adjusted resource transfer value is less than the original adjusted resource transfer value. In some embodiments, the method also includes providing a request to the user to deposit more resources into the account associated with the user in response to determining the vendor resource value is adequate to cover the adjusted resource transfer value.

Embodiments of the present disclosure address the above needs and/or achieve other advantages by providing apparatuses (e.g., a system, computer program product and/or other devices) and methods for dynamically generating optimized data queries to improve hardware efficiency and utilization. The system embodiments may comprise one or more memory devices having computer readable program code stored thereon, a communication device, and one or more processing devices operatively coupled to the one or more memory devices, wherein the one or more processing devices are configured to execute the computer readable program code to carry out said embodiments. In computer program product embodiments of the disclosure, the computer program product comprises at least one non-transitory computer readable medium comprising computer readable instructions for carrying out said embodiments. Computer implemented method embodiments of the disclosure may comprise providing a computing system comprising a computer processing device and a non-transitory computer readable medium, where the computer readable medium comprises configured computer program instruction code, such that when said instruction code is operated by said computer processing device, said computer processing device performs certain operations to carry out said embodiments.

### BRIEF DESCRIPTION OF THE DRAWINGS

Having thus described embodiments of the disclosure in general terms, reference will now be made the accompanying drawings, wherein:

FIG. 1 provides a block diagram illustrating a system environment for providing data processing channels for alternative resource usage, in accordance with embodiments of the present disclosure;

FIG. 2 provides a block diagram illustrating the entity system 200 of FIG. 1, in accordance with embodiments of the present disclosure;

FIG. 3 provides a block diagram illustrating a vendor data channel determination device 300 of FIG. 1, in accordance with embodiments of the present disclosure;

FIG. 4 provides a block diagram illustrating the computing device system 400 of FIG. 1, in accordance with embodiments of the present disclosure; and

FIG. 5 provides a flowchart illustrating a method of providing data processing channels for alternative resource usage in accordance with embodiments of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that utilizes one or more entity resources, including, but not limited to, one or more entity systems, one or more entity databases, one or more applications, one or more servers, or the like to perform one or more organization activities associated with the entity. In some embodiments, an entity may be any organization that develops, maintains, utilizes, and/or controls one or more applications and/or databases. Applications as described herein may be any software applications configured to perform one or more operations of the entity. Databases as described herein may be any datastores that store data associated with organizational activities associated with the entity. In some embodiments, the entity may be a financial institution which may include herein may include any financial institutions such as commercial banks, thrifts, federal and state savings banks, savings and loan associations, credit unions, investment companies, insurance companies and the like. In some embodiments, the financial institution may allow a customer to establish an account with the financial institution. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more applications provided by the entity and/or the system of the present disclosure. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Vendors often have loyalty programs for users in which accounts are created and used with a given vendor. However, traditional loyalty programs often require users to lock resources into a vendor's ecosystem without being able to easily use said resources with other vendors. Therefore, there exists a need to provide processing channels for alternative resource usage that allow for cross-channel resource usage.

Various embodiments of the present disclosure allow for users to deposit resources, such as cash, in an account associated with a primary vendor. Said resource is then attributed to the balance of the account associated with the user. The user can then use the balance of the account for resource transfer with the primary vendor, or secondary vendors outside of the primary vendor ecosystem. The primary vendor may receive an additional amount of resources for using the balance on resource transfers with a secondary vendor and/or provide discounts for using the balance on resource transfers with the primary vendor. The resulting infrastructure allows for vendor specific accounts to provide functionality for transaction with other vendors.

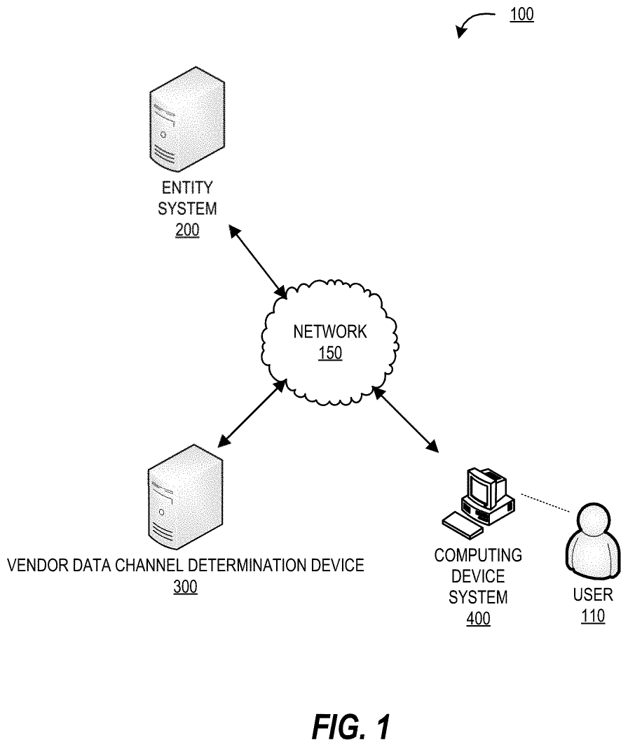

FIG. 1 provides a block diagram illustrating a system environment 100 for providing data processing channels for alternative resource usage. As illustrated in FIG. 1, the environment 100 includes a vendor data channel determination device 300, an entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees (e.g., application developers, database administrators, application owners, application end users, business analysts, finance agents, or the like) of an entity associated with the entity system 200.

The entity system(s) 200 may be any system owned or otherwise controlled by an entity to support or perform one or more process steps described herein. In some embodiments, the entity is a financial institution. In some embodiments, the entity may be a non-financial institution. In some embodiments, the entity may be any organization that utilizes one or more entity resources to perform one or more organizational activities.

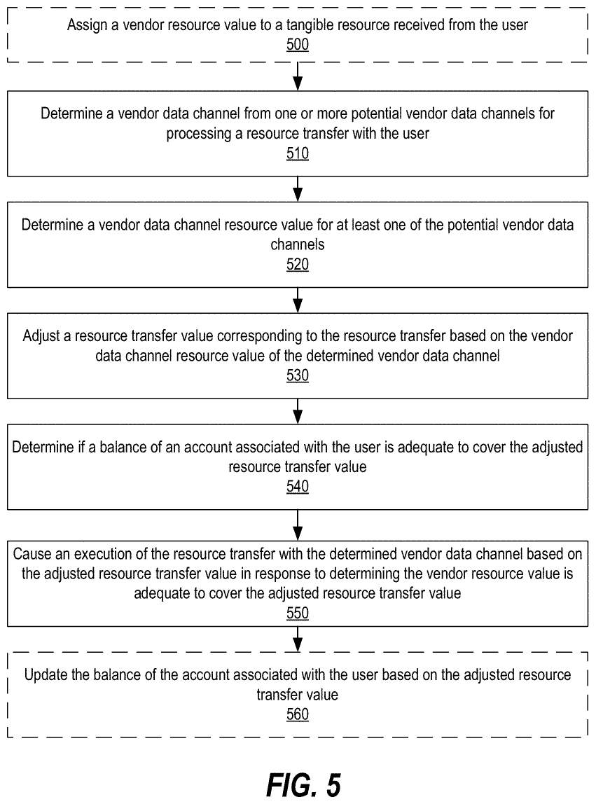

The vendor data channel determination device 300 is a system of the present disclosure for performing one or more process steps described herein. In some embodiments, the vendor data channel determination device 300 may be an independent system. In some embodiments, the vendor data channel determination device 300 may be a part of the entity system 200. For example, the method of FIG. 5 may be carried out by the entity system 200, the vendor data channel determination device 300, the computing device system 400, and/or a combination thereof.

The vendor data channel determination device 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the vendor data channel determination device 300 is configured to communicate information or instructions with the entity system 200, and/or the computing device system 400 across the network 150. While the entity system 200, the vendor data channel determination device 300, and the computing device system 400 are illustrated as separate components communicating via network 150, one or more of the components discussed here may be carried out via the same system (e.g., a single system may include the entity system 200 and the vendor data channel determination device 300).

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the vendor data channel determination device 300, and/or entity system 200 across the network 150.

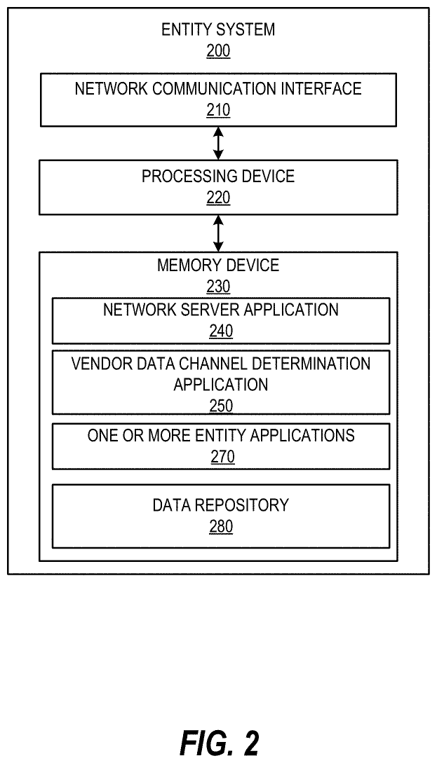

FIG. 2 provides a block diagram illustrating the entity system 200, in greater detail, in accordance with embodiments of the disclosure. As illustrated in FIG. 2, in one embodiment, the entity system 200 includes one or more processing devices 220 operatively coupled to a network communication interface 210 and a memory device 230. In certain embodiments, the entity system 200 is operated by a first entity, such as a financial institution. In some embodiments, the entity system 200 may be a multi-tenant cluster storage system.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a vendor data channel determination application 250, one or more entity applications 270, and a data repository 280 comprising data accessed, retrieved, and/or computed by the entity system 200. The one or more entity applications 270 may be any applications developed, supported, maintained, utilized, and/or controlled by the entity. The computer-executable program code of the network server application 240, the vendor data channel determination application 250, the one or more entity application 270 to perform certain logic, data-extraction, and data-storing functions of the entity system 200 described herein, as well as communication functions of the entity system 200.

The network server application 240, the vendor data channel determination application 250, and the one or more entity applications 270 are configured to store data in the data repository 280 or to use the data stored in the data repository 280 when communicating through the network communication interface 210 with the vendor data channel determination device 300, and/or the computing device system 400 to perform one or more process steps described herein. In some embodiments, the entity system 200 may receive instructions from the vendor data channel determination device 300 via the vendor data channel determination application 250 to perform certain operations. The vendor data channel determination application 250 may be provided by the vendor data channel determination device 300. The one or more entity applications 270 may be any of the applications used, created, modified, facilitated, and/or managed by the entity system 200.

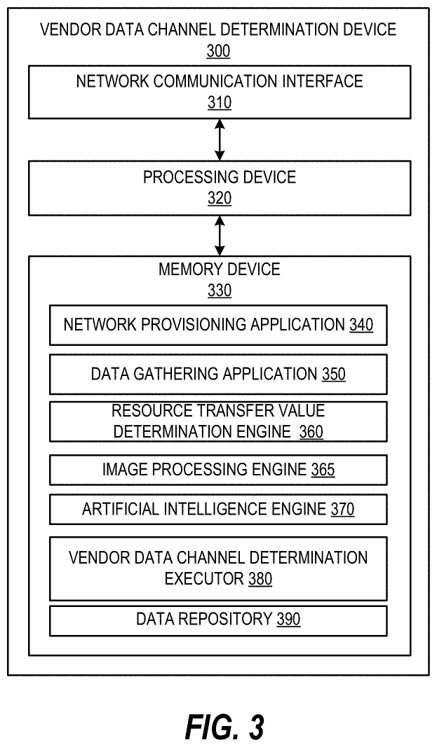

FIG. 3 provides a block diagram illustrating the vendor data channel determination device 300 in greater detail, in accordance with various embodiments. As illustrated in FIG. 3, in one embodiment, the vendor data channel determination device 300 includes one or more processing devices 320 operatively coupled to a network communication interface 310 and a memory device 330. In certain embodiments, the vendor data channel determination device 300 is operated by an entity, such as a financial institution. In some embodiments, the vendor data channel determination device 300 is owned or operated by the entity of the entity system 200. In some embodiments, the vendor data channel determination device 300 may be an independent system. In alternate embodiments, the vendor data channel determination device 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the vendor data channel determination device 300 described herein. For example, in one embodiment of the vendor data channel determination device 300, the memory device 330 includes, but is not limited to, a network provisioning application 340, a data gathering application 350, a resource transfer value determination engine 360, an image processing engine 365, an artificial intelligence engine 370, a vendor data channel determination executor 380, and a data repository 390 comprising any data processed or accessed by one or more applications in the memory device 330. The computer-executable program code of the network provisioning application 340, the data gathering application 350, the resource transfer value determination engine 360, the image processing engine 365, the artificial intelligence engine 370, and the vendor data channel determination executor 380 may instruct the processing device 320 to perform certain logic, data-processing, and data-storing functions of the vendor data channel determination device 300 described herein, as well as communication functions of the vendor data channel determination device 300.

The resource transfer value determination engine 360, the artificial intelligence engine 365, and/or the vendor data channel determination executor 380 may alone, or in combination, be configured to determine the vendor data channels associated with a given resource transfer. The resource transfer value determination engine 360, the artificial intelligence engine 365, and/or the vendor data channel determination executor 380 may include a vendor data channel database generated to assist in determining the vendor resource data channel associated with a given vendor and a resource value database generated to assist in determining the vendor data channel resource value associated with the vendor data channel. The vendor data channel database and the resource value database may be separate or combined (e.g., within data repository 390 or elsewhere within the memory device 330).

The network provisioning application 340, the data gathering application 350, the resource transfer value determination engine 360, the image processing engine 365, the artificial intelligence engine 370, and the vendor data channel determination executor 380 are configured to invoke or use the data in the data repository 390 when communicating through the network communication interface 310 with the entity system 200, and/or the computing device system 400. In some embodiments, the network provisioning application 340, the data gathering application 350, the resource transfer value determination engine 360, the image processing engine 365, the artificial intelligence engine 370, and the vendor data channel determination executor 380 may store the data extracted or received from the entity system 200, and the computing device system 400 in the data repository 390. In some embodiments, the network provisioning application 340, the data gathering application 350, the resource transfer value determination engine 360, the image processing engine 365, the artificial intelligence engine 370, and the vendor data channel determination executor 380 may be a part of a single application.

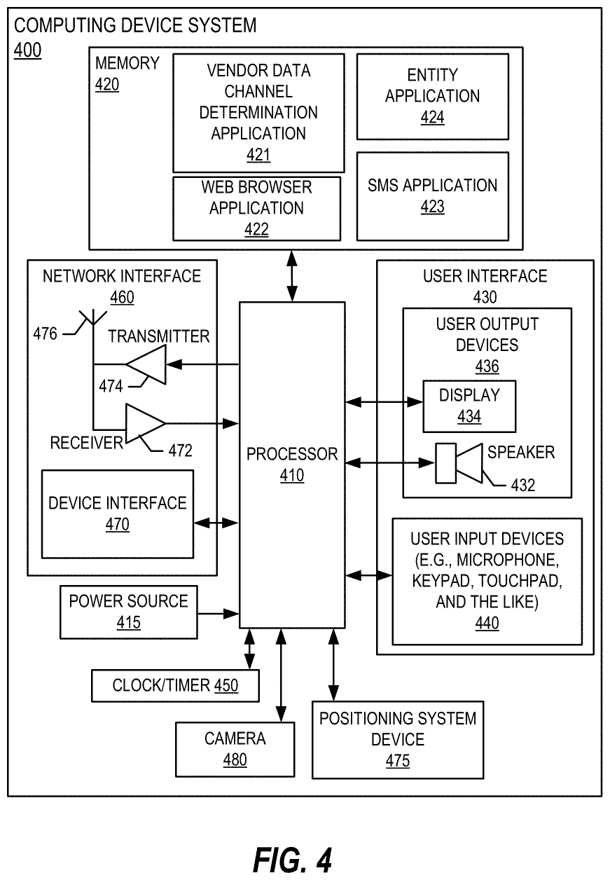

FIG. 4 provides a block diagram illustrating a computing device system 400 of FIG. 1 in more detail, in accordance with various embodiments. However, it should be understood that a mobile telephone is merely illustrative of one type of computing device system 400 that may benefit from, employ, or otherwise be involved with embodiments of the present disclosure and, therefore, should not be taken to limit the scope of embodiments of the present disclosure. Other types of computing devices may include portable digital assistants (PDAs), pagers, mobile televisions, electronic media devices, desktop computers, workstations, laptop computers, cameras, video recorders, audio/video player, radio, GPS devices, wearable devices, Internet-of-things devices, augmented reality devices, virtual reality devices, automated teller machine (ATM) devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include one or more displays 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a vendor data channel determination application 421, entity application 424. These applications also typically instructions to a graphical user interface (GUI) on the display 430 that allows the user 110 to interact with the entity system 200, the vendor data channel determination device 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the vendor data channel determination application 421 provided by the vendor data channel determination device 300 allows the user 110 to access the vendor data channel determination device 300. In some embodiments, the entity application 424 provided by the entity system 200 and the vendor data channel determination application 421 allow the user 110 to access the functionalities provided by the vendor data channel determination device 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

Referring now to FIG. 5, a method of providing data processing channels for alternative resource usage is provided. The method may be carried out by a system discussed herein (e.g., the entity system 200, the vendor data channel determination device 300, and/or the computing device system 400). An example system may include at least one non-transitory storage device and at least one processing device coupled to the at least one non-transitory storage device. In such an embodiment, the at least one processing device is configured to carry out the method discussed herein.

Referring now to optional Block 500 of FIG. 5, the method may include assigning a vendor resource value to a resource received from the user. The resource may be received in an ATM or other computing device system 400 (e.g., the user may deposit the resource into an ATM). The ATM or other computer device system 400 may be associated with a vendor. The resource received from the user may be a currency, such as fiat currency. The resource received from the user may be physical currency (e.g., the user may input cash into an ATM).

The system assigns a vendor resource value that corresponds to the value of the resource received. The vendor resource value may be representative of the value of the resource (e.g., in an instance in which the user deposits $100 into an ATM for transfer, the resource value may be $100). In some embodiments, the vendor resource value may be in the native resource type (e.g., if U.S. currency is inputted by the user, then the resource value would be U.S. Dollars). In some instances, the vendor resource value may be uniform resource type (e.g., the value of a given resource is converted into the uniform resource type and then assigned a resource value in the uniform resource type). For example, an ATM in a given country may assign a vendor resource value based on the given currency and therefore in an instance in which a different currency is inputted by the user, the value of the resource is converted into the value in the given currency.

Additionally or alternatively, the resource may be a cryptocurrency. In such an embodiment, the user may input wallet information or another type of identification that allows the given cryptocurrency to be transferred to the entity system 200. For example, the user may scan a QR code corresponding to the user's crypto wallet and a corresponding blockchain transaction is processed.

Additionally, the system may also use blockchain technology to represent physical resources that are received by an ATM. For example, the vendor resource value may be stored using blockchain technology in order to create a detailed record of inputted resources including transfers to other resource entities. The vendor resource value is a digital representation of the physical resource.

In various embodiments, the vendor resource value is attributed to a balance of an account associated with the user upon deposit of the resource by the user. The account associated with the user can also be associated with a given vendor (e.g., a primary vendor). A primary vendor is the vendor associated with the account associated with the user. Any other vendors not associated with the given account associated with the user is a secondary vendor. As such, a given vendor may be a primary or secondary vendor depending on the given account used by the user. For example, a user may have a first account associated with Vendor A in which Vendor A is a primary vendor and Vendor B is a secondary vendor, as well as a second account associated with Vendor B in which Vendor B is a primary vendor and Vendor A is a secondary vendor. As discussed herein, in some instances, the user may use an account associated with a given primary vendor with a secondary vendor.

The primary vendor may be in possession of the resource or have access to the resource, such that the primary vendor attributes the vendor resource value of the resource to the account associated with the user. For example, the resource may be possessed by the primary vendor after deposit by a user and before any transactions between the user and the primary vendor. The resource may be stored with a third-party entity, such as a financial institution.

The primary vendor may have a primary vendor device (e.g., an ATM or other device) for a user to deposit the resource that is attributed to the balance of the account associated with the user. The primary vendor device may be located in a primary vendor location, such as a store of the primary vendor. A user may have multiple accounts associated with said user for different vendors (e.g., a user may have a Vendor A account associated with Vendor A in which Vendor A is the primary vendor relating to said account and a Vendor B account associated with Vendor B in which Vendor B is the primary vendor relating to said account).

Referring now to Block 510 of FIG. 5, the method may include determining a vendor data channel from one or more potential vendor data channels for processing a resource transfer with a user. Each of the potential vendor data channels corresponds to a primary vendor or a secondary vendor. The vendor data channel may include information relating to the given vendor in order to facilitate a resource transfer. The vendor data channel information may include routing information or other identification information relating to the vendor, such that the resource transfer can be carried out. Each vendor may have a dedicated vendor data channel or subset of a vendor data channel configured to facilitate resource transfers.

The vendor data channel may be determined based on a selection by the user (e.g., the user inputs the vendor in which the resource transfer is intended, and the vendor data channel is retrieved thereby). Additionally or alternatively, the vendor data channel may be provided to the system by the vendor associated with said vendor data channel. For example, in an instance in which the user is attempting to use an account associated with a given primary vendor in a resource transfer between a secondary vendor and the user, the secondary vendor may communicate vendor data channel information for the given secondary vendor to the primary vendor (e.g., the entity system 200) for processing.

The system may also be programmed or have previously received one or more potential vendor data channels. For example, the system may have one or more vendors in which the given user and/or other users previously interact, such that the vendor data channels are already known to the system. Any such potential vendor data channels may be stored by the system and retrieved during the operations discussed herein. For example, the user may be presented with one or more potential vendors for a resource transfer in which the user may select one of the pre-selected vendors or input information relating to a new vendor. The vendor data channels stored by the system may include vendor data channels associated with primary vendors and vendor data channels associated with secondary vendors.

Referring now to Block 520 of FIG. 5, the method may include determining a vendor data channel resource value for at least one of the potential vendor data channels. The vendor data channel resource value may be the cost for using an account associated with a primary vendor in a resource transfer with the given vendor. The vendor data channel resource value may be based on the vendor associated with the given vendor data channel. The vendor data channel resource value may be different for primary vendors than secondary vendors. For example, the vendor data channel resource value is higher for a potential vendor data channel corresponding to the secondary vendor than a potential vendor data channel corresponding to the primary vendor.

The vendor data channel resource value is associated with a change in amount of a resource transfer based on the given vendor. For a vendor data channel associated with a primary vendor, the vendor data channel resource value may be a negative value, such that using the account associated with the primary vendor with said primary vendor results in a discount (e.g., the adjusted resource transfer value discussed in reference to Block 530 of FIG. 5 below is less than the original adjusted resource transfer value). Additionally or alternatively, the vendor data channel resource value for a vendor data channel associated with a secondary vendor may be a positive value, such that using the account associated with the primary vendor with the secondary vendor results in increased resource transfer value. In various embodiments, the vendor data channel resource value for a vendor data channel associated with a given vendor is based on the primary vendor associated with the account. For example, the vendor data channel resource value may be different for a vendor data channel associated with Vendor A in an instance in which Vendor A is a primary vendor than an instance in which Vendor A is a secondary vendor.

Referring now to Block 530 of FIG. 5, the method may also include adjusting a resource transfer value corresponding to the resource transfer based on the vendor data channel resource value of the determined vendor data channel. The resource transfer value may be the value of a given transaction. For example, in an instance a user is attempting to purchase product(s) and/or service(s) from a vendor, the resource transfer value may be the price of the given purchase.

The resource transfer value is adjusted based on the vendor data channel resource value of the determined vendor data channel. As discussed above, the vendor data channel resource value can be based on whether the vendor associated with the determined vendor data channel is a primary vendor or a secondary vendor (e.g., based on the account of the user being used for the transaction). Depending on the vendor data channel resource value of the determined vendor data channel, the resource transfer value may be increased or decreased. For example, in an instance in which the determined vendor data channel is associated with a primary vendor, the resource transfer value may remain the same or decrease (e.g., the user may receive a discount for using an account associated with the primary vendor for a resource transfer with the primary vendor), and in an instance in which the determined vendor data channel is associated with a secondary vendor, the resource transfer value may increase (e.g., the user may pay an additional amount in addition to the resource transfer value to use an account associated with a given primary vendor for a resource transfer with a secondary vendor).

The vendor data channel resource value may be credited by the primary vendor or received by the primary vendor. For example, in a resource transfer between a user and a secondary vendor, the primary vendor may receive the difference between the original resource transfer value and the adjusted resource transfer value to facilitate the transfer (e.g., the primary vendor may receive a portion of the resource transfer value after completing the resource transfer with the secondary vendor), and in a resource transfer between a user and a primary vendor, the primary vendor may accept less than the original transfer resource value for a given transaction.

Referring now to Block 540 of FIG. 5, the method may include determining whether the balance of the account associated with the user is adequate to cover the adjusted resource transfer value. In such an instance, the balance of the account associated with the user is compared to the adjusted resource transfer value to determine whether the user has an adequate amount of resources in the given account to facilitate the resource transfer. In an instance in which the balance of the account associated with the user is adequate to cover the adjusted resource transfer value, the system may proceed with the steps of Block 550 discussed below.

In an instance in which the balance is not adequate to cover the adjusted resource transfer, the system may notify the user of the balance deficiency. For example, the system may provide a request to the user to deposit more resources into the account associated with the user in response to determining the vendor resource value is adequate to cover the adjusted resource transfer value. The notification may be provided to a user device (e.g., a mobile device) or a device associated with the vendor involved in the resource transfer (e.g., a point of sale device associated with the given vendor).

In some instances, a partial resource transfer may be carried out based on the balance of the account. For example, a certain amount of the adjusted resource transfer value less than the balance of the account may be transferred, and the user may complete the given resource transfer in another method (e.g., paying cash or using a credit card).

Referring now to Block 550 of FIG. 5, the method may include causing an execution of the resource transfer with the determined vendor data channel based on the adjusted resource transfer value in response to determining the vendor resource value is adequate to cover the adjusted resource transfer value.

In an instance in which the resource transfer is between a user and a primary vendor, the primary vendor may merely adjust the balance of the account associated with the user to reflect the execution of the resource execution (e.g., since the primary vendor already has possession or right of possession to the resource, no additional transfer of resources is completed, such that the given resource transfer may be a paper transaction).

In an instance in which the resource transfer is between a user and a secondary vendor, the primary vendor may transmit the resource or rights to the resource based on the resource transfer value in response to the execution of the resource transfer. The amount transferred to the secondary vendor may be the original resource transfer value (less the vendor data channel resource value of the determined vendor data channel). In some instances, vendors may have agreements with other vendors for transfer that may change the amount of the given resource transfer value that is transferred (e.g., two vendors may have an agreement in which the primary vendor may receive a referral bonus that is a percentage of the resource transfer value). Upon receipt of the resource transfer, the resource transfer between the user and the secondary vendor may be complete (e.g., the user receives the product(s) and/or services in which said user is contracting).

Referring now to optional Block 560 of FIG. 5, the method may also include updating the balance of the account associated with the user based on the adjusted resource transfer value. The updating of the balance of the account may be part of the execution of the resource transfer. As such, at the end of the resource transfer, the balance of the account is reduced based by the adjusted resource transfer value. The balance and other account information may be stored by the system (e.g., entity system 200) for future use. Additionally, the reward points and/or other rewards may be attributed to an account based on resource transfers. As such, the balance may also be updated based on any rewards earned from a resource transfer (e.g., an account may get cash back for using an account associated with a primary vendor for resource transfer with the primary vendor).

As will be appreciated by one of skill in the art, the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present disclosure may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments of the present disclosure may also be written in conventional procedural programming languages, such as the “C” programming language or similar programming languages.

Embodiments of the present disclosure are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the disclosure.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present disclosure are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

1. A system for providing data processing channels for alternative resource usage, the system comprising:
at least one non-transitory storage device; and
at least one processing device coupled to the at least one non-transitory storage device, wherein the at least one processing device is configured to:
assign a vendor resource value to a tangible resource received from a user, wherein the vendor resource value corresponds to a value of the tangible resource received, wherein the vendor resource value is attributed to a balance of an account associated with the user;
determine a vendor data channel from one or more potential vendor data channels for processing a resource transfer with the user, wherein each of the potential vendor data channels corresponds to a primary vendor or a secondary vendor;
determine a vendor data channel resource value for at least one of the potential vendor data channels, wherein the vendor data channel resource value is higher for a potential vendor data channel corresponding to the secondary vendor than a potential vendor data channel corresponding to the primary vendor;
adjust a resource transfer value corresponding to the resource transfer based on the vendor data channel resource value of the determined vendor data channel;
determine whether the balance of the account associated with the user is adequate to cover the adjusted resource transfer value; and
in response to determining the vendor resource value is adequate to cover the adjusted resource transfer value, cause an execution of the resource transfer with the determined vendor data channel based on the adjusted resource transfer value.

2. (canceled)

3. The system of claim 2, wherein the resource is received from the user at a device located in a primary vendor location.

4. The system of claim 1, wherein the at least one processing device is further configured to update the balance of the account associated with the user based on the adjusted resource transfer value.

5. The system of claim 1, wherein the account associated with the user is associated with one or more primary vendors.

6. The system of claim 1, wherein the vendor data channel resource value for vendor data channels associated with the primary vendor is a negative value, wherein the adjusted resource transfer value is less than the original adjusted resource transfer value.

7. The system of claim 1, wherein the at least one processing device is further configured to provide a request to the user to deposit more resources into the account associated with the user in response to determining the vendor resource value is adequate to cover the adjusted resource transfer value.

8. A computer program product for providing data processing channels for alternative resource usage, the computer program product comprising at least one non-transitory computer-readable medium having computer-readable program code portions embodied therein, the computer-readable program code portions comprising:
an executable portion configured to assign a vendor resource value to a tangible resource received from a user, wherein the vendor resource value corresponds to a value of the tangible resource received, wherein the vendor resource value is attributed to a balance of an account associated with the user;
an executable portion configured to determine a vendor data channel from one or more potential vendor data channels for processing a resource transfer with the user, wherein each of the potential vendor data channels corresponds to a primary vendor or a secondary vendor;
an executable portion configured to determine a vendor data channel resource value for at least one of the potential vendor data channels, wherein the vendor data channel resource value is higher for a potential vendor data channel corresponding to the secondary vendor than a potential vendor data channel corresponding to the primary vendor;
an executable portion configured to adjust a resource transfer value corresponding to the resource transfer based on the vendor data channel resource value of the determined vendor data channel;
an executable portion configured to determine whether the balance of the account associated with the user is adequate to cover the adjusted resource transfer value; and
an executable portion configured to cause an execution of the resource transfer with the determined vendor data channel based on the adjusted resource transfer value in response to determining the vendor resource value is adequate to cover the adjusted resource transfer value.

9. (canceled)

10. The computer program product of claim 9, wherein the resource is received from the user at a device located in a primary vendor location.

11. The computer program product of claim 8, wherein the computer-readable program code portions also comprise an executable portion configured to update the balance of the account associated with the user based on the adjusted resource transfer value.

12. The computer program product of claim 8, wherein the account associated with the user is associated with one or more primary vendors.

13. The computer program product of claim 8, wherein the vendor data channel resource value for vendor data channels associated with the primary vendor is a negative value, wherein the adjusted resource transfer value is less than the original adjusted resource transfer value.

14. The computer program product of claim 8, wherein the computer-readable program code portions also comprise an executable portion configured to provide a request to the user to deposit more resources into the account associated with the user in response to determining the vendor resource value is adequate to cover the adjusted resource transfer value.

15. A computer-implemented method for providing data processing channels for alternative resource usage, the method comprising:
assigning a vendor resource value to a tangible resource received from a user, wherein the vendor resource value corresponds to a value of the tangible resource received, wherein the vendor resource value is attributed to a balance of an account associated with the user;
determining a vendor data channel from one or more potential vendor data channels for processing a resource transfer with the user, wherein each of the potential vendor data channels corresponds to a primary vendor or a secondary vendor;
determining a vendor data channel resource value for at least one of the potential vendor data channels, wherein the vendor data channel resource value is higher for a potential vendor data channel corresponding to the secondary vendor than a potential vendor data channel corresponding to the primary vendor;
adjusting a resource transfer value corresponding to the resource transfer based on the vendor data channel resource value of the determined vendor data channel;
determining whether the balance of the account associated with the user is adequate to cover the adjusted resource transfer value; and
in response to determining the vendor resource value is adequate to cover the adjusted resource transfer value, causing an execution of the resource transfer with the determined vendor data channel based on the adjusted resource transfer value.

16. (canceled)

17. The method of claim 15, further comprising updating the balance of the account associated with the user based on the adjusted resource transfer value.

18. The method of claim 15, wherein the account associated with the user is associated with one or more primary vendors.

19. The method of claim 15, wherein the vendor data channel resource value for vendor data channels associated with the primary vendor is a negative value, wherein the adjusted resource transfer value is less than the original adjusted resource transfer value.

20. The method of claim 15, further comprising providing a request to the user to deposit more resources into the account associated with the user in response to determining the vendor resource value is adequate to cover the adjusted resource transfer value.
